(19) United States
(12) Patent Application Publication
(10) Pub. No.: US 2024/0093754 A1
(43) Pub. Date: Mar. 21, 2024

(54) MAGNETORHEOLOGICAL FLUID AND VIBRATION DAMPING DEVICE

(71) Applicant: SEIKO EPSON CORPORATION, TOKYO (JP)

(72) Inventor: Sukenori ICHIKAWA, SUWA-SHI (JP)

(21) Appl. No.: 18/467,747

(22) Filed: Sep. 15, 2023

(30) Foreign Application Priority Data
Sep. 16, 2022 (JP) 2022-147689

(51) Int. Cl. F16F 9/53

(52) U.S. Cl. CPC F16F 9/535; F16F 2222/12; F16F 2224/0208; F16F 2224/045

(57) ABSTRACT

A magnetorheological fluid contains: a dispersion medium; and magnetic metal particles dispersed in the dispersion medium and having a coercive force of 398 A/m or less, which is equivalent to 5 Oe or less. A shear yield stress τ_{A} measured at a shear rate of 0.01/s after a magnetic field of 0.5 T is continuously applied for 480 seconds and the magnetic field is removed is less than 2.0 times a shear yield stress τ_{B} measured at a shear rate of 0.01/s before the magnetic field is applied.

The present application is based on, and claims priority from JP Application Serial Number 2022-147689, filed Sep. 16, 2022, the disclosure of which is hereby incorporated by reference herein in its entirety.

### BACKGROUND

### 1. Technical Field

The present disclosure relates to a magnetorheological fluid and a vibration damping device.

### 2. Related Art

A magnetorheological fluid is, for example, a fluid obtained by dispersing magnetic metal particles in a dispersion medium. When a magnetic field is applied to the magnetorheological fluid, the magnetic metal particles are magnetized and aligned in a magnetic field direction. Accordingly, a chain cluster is formed, and a viscosity of the fluid changes. Therefore, use of a vibration damping device, a braking device, or the like is studied using the change in the viscosity.

In these devices, for example, by repeating application and removal of the magnetic field, the viscosity of the magnetorheological fluid is adjusted, and various functions such as vibration damping and braking are implemented.

For example, JP-A-10-032114 discloses a magnetorheological fluid in which iron carbonyl particles and fumed silica particles are dispersed in a liquid containing a poly-α-olefin. It is disclosed that since the magnetorheological fluid has an ability to reversibly change fluidity under an influence of the applied magnetic field, the magnetorheological fluid is used in, for example, a shock absorber, a vibration damping material (a vibration damping device), or a torque transmission device.

In the magnetorheological fluid disclosed in JP-A-10-032114, when the magnetic field is applied and then removed, the viscosity may not sufficiently return to a state before the application of the magnetic field. In this case, since a sufficient viscosity change width cannot be secured, there is a risk that various functions such as vibration damping and braking may be hindered.

### SUMMARY

A magnetorheological fluid according to an application example of the present disclosure contains: a dispersion medium; and magnetic metal particles dispersed in the dispersion medium and having a coercive force of 398 A/m or less, which is equivalent to 5 Oe or less. A shear yield stress τ_{A} measured at a shear rate of 0.01/s after a magnetic field of 0.5 T is continuously applied for 480 seconds and the magnetic field is removed is less than 2.0 times a shear yield stress τ_{B} measured at a shear rate of 0.01/s before the magnetic field is applied.

A vibration damping device according to an application example of the present disclosure includes: the magnetorheological fluid according to the application example of the present disclosure; a container configured to store the magnetorheological fluid; and a magnetic field generation unit configured to generate a magnetic field to act on the magnetorheological fluid stored in the container.

### BRIEF DESCRIPTION OF THE DRAWINGS

FIG. 1 is a graph showing changes in shear yield stresses measured during switching of application of a magnetic field to a magnetorheological fluid according to an embodiment.

FIG. 2 is a graph showing changes in shear yield stresses measured while application and removal of the magnetic field are repeated six times.

FIG. 3 is a cross-sectional view schematically showing the magnetorheological fluid according to the embodiment.

FIG. 4 is a cross-sectional view schematically showing a magnetic metal particle shown in FIG. 3.

FIG. 5 is a longitudinal cross-sectional view showing a vibration damping device according to the embodiment.

### DESCRIPTION OF EMBODIMENTS

Hereinafter, a magnetorheological fluid and a vibration damping device according to the present disclosure will be described in detail based on an embodiment shown in the accompanying drawings.

### 1. Magnetorheological Fluid

First, a magnetorheological fluid according to an embodiment will be described.

The magnetorheological fluid is a fluid that acts as a liquid when no magnetic field is applied, and acts as a semi-solid when a magnetic field is applied. By utilizing such a change in a viscosity, the magnetorheological fluid can be used in various devices or the like that exhibit various functions by controlling a stress.

### 1.1. Characteristics of Magnetorheological Fluid

The magnetorheological fluid according to the embodiment is a fluid in which, when a shear stress measured at a shear rate of 0.01/s after a magnetic field of 0.5 T is continuously applied for 480 seconds and the magnetic field is removed is referred to as a “shear yield stress τ_{A}”, and a shear stress measured at a shear rate of 0.01/s before the magnetic field is applied is referred to as a “shear yield stress τ_{B}”, a multiple of the shear yield stress τ_{A} with respect to the shear yield stress τ_{B} is less than 2.0 times.

Such a magnetorheological fluid is a fluid capable of restoring a low viscosity equivalent to that before application when a predetermined magnetic field is applied and then removed. In the present specification, such characteristics are referred to as “low-viscosity recoverability”. When the multiple of the shear yield stress τ_{A} with respect to the shear yield stress τ_{B} is less than 2.0 times, sufficient low-viscosity recoverability can be obtained. Accordingly, it is possible to sufficiently secure a viscosity change width between a time of applying the magnetic field and a time of removing the magnetic field. In the present specification, such a viscosity change width is referred to as a “viscosity change width”. When a coercive force of magnetic metal particles contained in the magnetorheological fluid is 398 A/m or less (5 Oe or less), the low viscosity can be sufficiently recovered. Therefore, when the magnetorheological fluid contains the magnetic metal particles with such a low coercive force, the viscosity change width is stabilized even if application and removal of the magnetic field are repeated. Accordingly, a magnetorheological fluid exhibiting good characteristics over a long period of time can be implemented. As a result, high performance and long-term reliability can be imparted to various devices using the magnetorheological fluid.

The shear yield stress of the magnetorheological fluid is a shear stress measured at a shear rate of 0.01/s. The shear stress is measured by, for example, a Rheometer MCR102 manufactured by Anton Paar GmbH. In addition, as a device for applying the magnetic field during the measurement, a magnetic field application attachment MRD70 or the like manufactured by Anton Paar GmbH can be used.

The shear stress is measured by sampling the magnetorheological fluid (200 μL), rotating a rotor having a diameter of 20 mm in a state in which the magnetorheological fluid is sandwiched between a sample stage of a device and the rotor, and switching the application of the magnetic field while applying a predetermined shear rate. A strength of the magnetic field is set to 0.5 T, and a gap between the sample stage and the rotor is set to 0.5 mm.

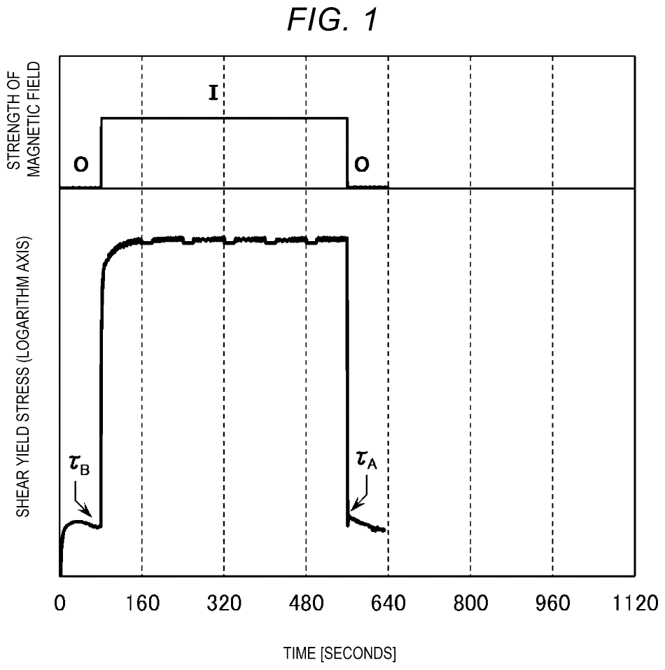

FIG. 1 is a graph showing changes in shear yield stresses measured while switching application of the magnetic field to the magnetorheological fluid according to the embodiment. In FIG. 1, a magnetic field application period is defined as I, and a magnetic field removal period is defined as O. A length of the magnetic field application period I is 480 seconds. A vertical axis in FIG. 1 is an axis representing a strength of the applied magnetic field and an axis representing a measured shear yield stress in logarithm. A horizontal axis in FIG. 1 represents an elapsed time from start of the measurement of the shear yield stress.

During switching of the application of the magnetic field, the shear yield stress also varies correspondingly. When switching from the magnetic field removal period O to the magnetic field application period I, the shear yield stress instantaneously increases. The shear yield stress immediately before the increase is the “shear yield stress τ_{B}” as described above. The shear yield stress immediately before the increase refers to a minimum value measured in a period from a switching time point of the magnetic field to five seconds before.

On the other hand, when switching from the magnetic field application period I to the magnetic field removal period O, the shear yield stress instantaneously decreases. The shear yield stress immediately after the decrease is the “shear yield stress τ_{A}” as described above. The shear yield stress immediately after the decrease refers to a maximum value measured in a period from a switching time point to the magnetic field removal period O to 80 seconds later.

In the magnetorheological fluid according to the embodiment, as described above, the shear yield stress τ_{A} is less than 2.0 times the shear yield stress τ_{B}. Accordingly, the viscosity change width can be stabilized, and a magnetorheological fluid having good characteristics over a long period of time can be obtained.

The multiple of the shear yield stress τ_{A} with respect to the shear yield stress τ_{B} is preferably less than 1.7 times, and more preferably less than 1.5 times. The multiple can be adjusted according to, for example, a coercive force, an average particle diameter, and a particle size distribution of the magnetic metal particles. For example, the above multiple tends to decrease by decreasing the coercive force or increasing the average particle diameter. In addition, the above-described multiple tends to decrease by decreasing the particle size distribution, for example, a ratio D90/D50 to be described later.

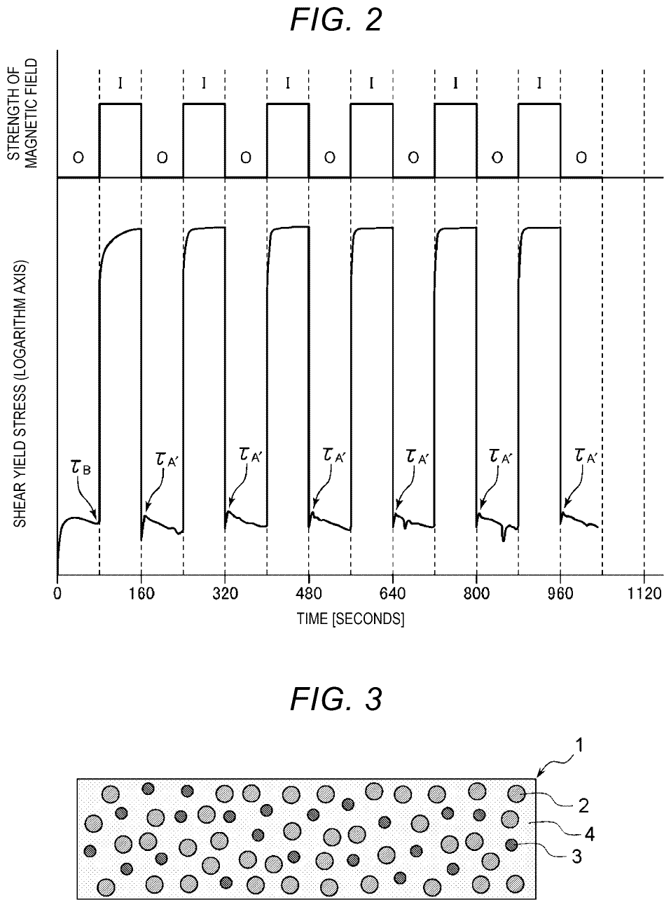

In addition, the application and the removal of the magnetic field may be repeated a plurality of times. FIG. 2 is a graph showing changes in shear yield stresses measured while application and removal of the magnetic field are repeated six times. A length of one magnetic field application period I and a length of one magnetic field removal period O shown in FIG. 2 are each 80 seconds, respectively. That is, in FIG. 2, a total of six magnetic field application periods I is 480 seconds.

As shown in FIG. 2, when there are six magnetic field application periods I, six magnetic field removal periods O are present. Therefore, maximum values of the shear yield stress in the magnetic field removal periods O each are defined as a shear yield stress τ_{A}′. As a result, six shear yield stresses τ_{A}′ are present in FIG. 2.

In the magnetorheological fluid according to the embodiment, a maximum value τ_{A′_MAX} among the six shear yield stresses τ_{A}′ is also preferably less than 2.0 times, more preferably 1.7 times or less, and still more preferably 1.5 times or less the shear yield stress τ_{B}. For example, in the case of FIG. 2, the shear yield stress τ_{A}′ located around 645 seconds is the maximum value τ_{A′_MAX}. When the maximum value τ_{A′_MAX} is within the above range, the viscosity change width of the magnetorheological fluid can be further stabilized, and a magnetorheological fluid having good characteristics over a longer period of time can be obtained.

### 1.2. Configuration of Magnetorheological Fluid

FIG. 3 is a cross-sectional view schematically showing a magnetorheological fluid 1 according to the embodiment. The magnetorheological fluid 1 shown in FIG. 3 contains magnetic metal particles 2, additives 3, and a dispersion medium 4. The magnetic metal particles 2 and the additives 3 are dispersed in the dispersion medium 4.

### 1.2.1. Magnetic Metal Particles

The coercive force of the magnetic metal particles 2 is 398 A/m (5 Oe) or less as described above. The coercive force refers to a value of an external magnetic field in an opposite direction required to return a magnetized magnetic material to an unmagnetized state. That is, the coercive force means a resistance force against the external magnetic field. Since residual magnetization of the magnetic metal particles 2 having the coercive force within the above range is small, the magnetic metal particles 2 are less likely to be magnetized when no magnetic field is applied, whereas the magnetic metal particles 2 are magnetized with the application of the magnetic field, so that followability of the magnetization to the change in the magnetic field is high. Therefore, the magnetorheological fluid 1 containing the magnetic metal particles 2 is excellent in responsiveness to the change in the magnetic field. Since the magnetic metal particles 2 having such a low coercive force are less likely to be aggregated when no magnetic field is applied, the magnetic metal particles 2 can be uniformly dispersed in the dispersion medium 4 even at a high concentration. Therefore, the magnetorheological fluid 1 containing the magnetic metal particles 2 has low-viscosity recoverability.

In addition, when the low-viscosity recoverability is sufficient, the viscosity change width can be sufficiently secured between the time of applying the magnetic field and the time of removing the magnetic field. When the coercive force of the magnetic metal particles 2 is within the above range, since hysteresis can be kept small, the viscosity change width can be stabilized even when the application and the removal of the magnetic field are repeated. Accordingly, the magnetorheological fluid 1 exhibiting good characteristics over a long period of time can be implemented.

The coercive force of the magnetic metal particles 2 is preferably 239 A/m (3 Oe) or less, and more preferably 159 A/m (2 Oe) or less.

The coercive force of the magnetic metal particles 2 is measured using, for example, a vibrating sample magnetometer (VSM). Examples of the vibrating sample magnetometer include TM-VSM1550HGC manufactured by Tamakawa Co., Ltd. A maximum applied magnetic field at the time of measuring the coercive force is, for example, 1194 kA/m (15 kOe). When separating the magnetic metal particles 2 from the magnetorheological fluid 1, for example, a method of removing the dispersion medium 4 with an organic solvent such as normal hexane or acetone is used.

Saturation magnetization of the magnetic metal particles 2 is preferably 50 emu/g or more, and more preferably 100 emu/g or more. The saturation magnetization is a value of magnetization in a case where magnetization exhibited by a magnetic material when a sufficiently large magnetic field is applied from outside is constant regardless of the magnetic field. As the saturation magnetization of the magnetic metal particles 2 becomes higher, a function thereof as a magnetic material can be more sufficiently exhibited. Specifically, since a moving speed of the magnetic metal particles 2 in the magnetic field can be increased, magnetic field responsiveness can be enhanced. In addition, the viscosity change width can be further increased.

An upper limit value of the saturation magnetization of the magnetic metal particles 2 is not particularly limited, and is preferably 220 emu/g or less from the viewpoint of ease of material selection suitable for balancing performance and cost.

The saturation magnetization of the magnetic metal particles 2 can be measured by a vibrating sample magnetometer (VSM) or the like. A maximum applied magnetic field at the time of measuring the saturation magnetization is, for example, 1194 kA/m (15 kOe) or more.

An average particle diameter of the magnetic metal particles 2 is preferably 0.05 μm or more and 20.0 μm or less, more preferably 0.1 μm or more and 10.0 μm or less, and still more preferably 0.5 μm or more and 5.0 μm or less. When the average particle diameter of the magnetic metal particles 2 is within the above range, aggregation and precipitation of the magnetic metal particles 2 in a state in which no magnetic field is applied can be prevented. In addition, it is possible to prevent a decrease in the magnetic field responsiveness.

When the average particle diameter of the magnetic metal particles 2 is less than the lower limit value, aggregation of the magnetic metal particles 2 may easily occur even when no magnetic field is applied, depending on a constituent material of the magnetic metal particles 2. In addition, the viscosity change width may decrease. On the other hand, when the average particle diameter of the magnetic metal particles 2 exceeds the upper limit value, the magnetic metal particles 2 may precipitate and unevenly distributed in the dispersion medium 4, depending on the constituent material of the magnetic metal particles 2.

A volume-based particle size distribution can be measured by a laser diffraction and dispersion method, and the average particle diameter of the magnetic metal particles 2 can be obtained based on a cumulative distribution curve obtained based on the particle size distribution. Specifically, in the cumulative distribution curve, a particle diameter at which a cumulative value from a small diameter side is 50% (a median diameter) is an average particle diameter D50 of the magnetic metal particles 2. Examples of a device for measuring the particle size distribution by the laser diffraction and dispersion method include MT3300 series manufactured by Microtrac BEL Corporation.

In the cumulative distribution curve of the particle size distribution obtained for the magnetic metal particles 2, a particle diameter at which the cumulative value from the small diameter side is 90% is a 90% particle diameter D90 of the magnetic metal particles 2. In the magnetic metal particles 2, a ratio D90/D50 of the 90% particle diameter D90 to the average particle diameter D50 is preferably 3.0 or less, more preferably 2.0 or less, and still more preferably 1.7 or less. Accordingly, since a content of coarse magnetic metal particles 2 is low, it is possible to prevent the coarse magnetic metal particles 2 from attracting and aggregating surrounding relatively small magnetic metal particles 2 and thus forming aggregates. When the aggregates are generated, there is a risk that the aggregates are likely to precipitate due to own weight, the viscosity change width may decrease, or the viscosity change width may not be stable.

A content of the magnetic metal particles 2 is preferably 40 mass % or more and 95 mass % or less, more preferably 50 mass % or more and 90 mass % or less, and still more preferably 60 mass % or more and 85 mass % or less, with respect to the total amount of the magnetorheological fluid 1. Accordingly, an appropriate viscosity can be obtained in the magnetorheological fluid 1 at the time of applying the magnetic field and at the time of removing the magnetic field, and the viscosity change width of the magnetorheological fluid 1 can be sufficiently increased.

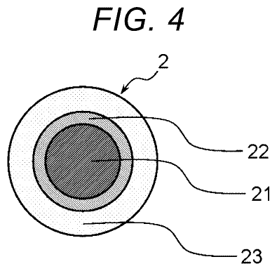

FIG. 4 is a cross-sectional view schematically showing the magnetic metal particle 2 shown in FIG. 3.

The magnetic metal particle 2 shown in FIG. 4 includes a particle body 21, an oxide film 22 provided on a surface of the particle body 21, and a surface modification film 23 provided on a surface of the oxide film 22. The oxide film 22 and the surface modification film 23 may be provided as necessary, and one or both of the oxide film 22 and the surface modification film 23 may be omitted.

### 1.2.1.1. Particle Body

Examples of a constituent material of the particle body 21 include a Fe-based metal material, a Ni-based metal material, and a Co-based metal material, and one or more of these composite materials are used. Alternatively, a composite material of the metal-based magnetic material and an oxide-based magnetic material may be used. Among these, as the constituent material of the particle body 21, a Fe-based metal material having large saturation magnetization is preferably used.

The Fe-based metal material is a metal material containing Fe as a main component. The main component means that a Fe content in the Fe-based metal material is 50% or more in terms of an atomic ratio. Such a Fe-based metal material has higher saturation magnetization and higher toughness and strength than ferrite and the like. Therefore, the Fe-based metal material is useful as the constituent material of the particle body 21.

In addition to Fe, the Fe-based metal material may contain an element exhibiting ferromagnetism alone, such as Ni or Co, and may contain at least one selected from the group consisting of Cr, Nb, Cu, Al, Mn, Mo, Si, Sn, B, C, P, Ti, and Zr according to target characteristics. In addition, the Fe-based metal material may contain inevitable impurities as long as effects of the embodiment are not impaired.

The inevitable impurities are impurities that are unintentionally mixed in a raw material or during production. Examples of the inevitable impurities include O, N, S, Na, Mg, and K.

Such a Fe-based metal material is not particularly limited, and examples thereof include pure iron, carbonyl iron, and Fe-based alloy materials such as Fe—Si—Al based alloys, for example, Sendust, and Fe—Ni based, Fe—Co based, Fe—Ni—Co based, Fe—Si—B based, Fe—Si—Cr—B based, Fe—Si—B—C based, Fe—Si—B—Cr—C based, Fe—Si—Cr based, Fe—B based, Fe—P—C based, Fe—Co—Si—B based, Fe—Si—B—Nb based, Fe—Si—B—Nb—Cu based, Fe—Zr—B based, Fe—Cr based, and Fe—Cr—Al based alloys.

The constituent material of the particle body 21 may be an amorphous metal material, a crystal metal material, or a microcrystal (nanocrystal) metal material. Among these, the amorphous metal material or the microcrystal metal material is preferably used. The microcrystal metal material refers to a metal material in which microcrystals (nanocrystals) having a crystal grain diameter of 100 nm or less are present. Since these materials have higher toughness and strength than metal oxides and the like, it is possible to effectively prevent wear, chipping, and the like of the particle body 21. As a result, the magnetorheological fluid 1 whose viscosity change width is particularly stable can be implemented.

Examples of the amorphous metal material include binary or multi-component Fe-based amorphous alloys such as Fe—Si—B based, Fe—Si—Cr—B based, Fe—Si—B—C based, Fe—Si—B—Cr—C based, Fe—Si—Cr based, Fe—B based, Fe—B—C based, Fe—P—C based, Fe—Co—Si—B based, Fe—Si—B—Nb based, and Fe—Zr—B based amorphous alloys, Ni-based amorphous alloys such as Ni—Si—B based and Ni—P—B based amorphous alloys, and Co-based amorphous alloys such as Co—Si—B based amorphous alloys.

Examples of the microcrystal metal material include Fe-based nanocrystal alloys such as Fe—Si—B—Nb—Cu-based, Fe—Zr—B-based, Fe—Hf—B-based, Fe—Nb—B-based, Fe—Zr—B—Co-based, Fe—Hf—B—Co-based, Fe—Nb—B—Co-based, and Fe—Si—B—P—Cu-based nanocrystal alloys.

Examples of the Fe-based metal material include an alloy in which a Si content is preferably 1.0 atom % or more and 30.0 atom % or less, more preferably 1.5 atom % or more and 13.0 atom % or less, and still more preferably 2.0 atom % or more and 7.0 atom % or less. Since such an alloy has high magnetic permeability, the saturation magnetization tends to be high. Accordingly, the magnetic field responsiveness of the magnetic metal particles 2 can be enhanced.

In addition, the Fe-based metal material may contain at least one of B (boron) having a content of 5.0 atom % or more and 16.0 atom % or less and C (carbon) having a content of 0.5 atom % or more and 5.0 atom % or less. These elements promote amorphization, and contribute to formation of a stable amorphous structure or nanocrystal structure in the magnetic metal particles 2.

Further, the Fe-based metal material preferably contains Cr (chromium) having a content of 1.0 atom % or more and 8.0 atom % or less. Accordingly, corrosion resistance of the magnetic metal particles 2 can be enhanced.

A total content of impurities is preferably 1.0 atom % or less. At this level, even if the impurities are contained, the effects of the magnetic metal particles 2 are not impaired.

An example of a particularly preferred Fe-based metal material is an alloy containing Fe as a main component and having a Si content of 2.0 mass % or more and 9.0 mass % or less, a B content of 1.0 mass % or more and 5.0 mass % or less, and a Cr content of 1.0 mass % or more and 5.0 mass % or less. Such a Fe-based metal material has good amorphous formability, and therefore has a low coercive force and high saturation magnetization. In addition, the corrosion resistance is high by containing Cr.

The constituent elements and the composition of the particle body 21 can be identified by an ICP emission spectrometry defined in JIS G 1258:2014, a spark emission spectrometry defined in JIS G 1253:2002, or the like. When the particle body 21 is covered with a coating film and the like, the constituent elements and the composition can be measured by the above method after the coating film and the like are removed by a chemical or physical method. After the magnetic metal particles 2 are cut, a portion of the particle body 21, which is a core, may be analyzed by an analysis device such as an electron probe micro analyzer (EPMA) or an energy dispersive X-ray spectroscopy (EDX).

The particle body 21 may be a particle produced by any method. Examples of a production method include various atomization methods such as a water atomization method, a gas atomization method, and a rotary water flow atomization method, as well as a pulverization method and a carbonyl method. Among these, according to the atomization methods, the particle body 21 having a particle shape closer to a true sphere is obtained. Such a particle body 21 is less likely to be aggregated.

### 1.2.1.2. Oxide Film

The oxide film 22 is a film provided on the surface of the particle body 21. The oxide film 22 is interposed between the particle body 21 and the surface modification film 23 to be described later, and enhances adhesion of the surface modification film 23 to the particle body 21. The oxide film 22 can protect the particle body 21 and prevent aggregation, and can enhance moisture absorption resistance and rust resistance of the particle body 21. Although it is preferable that the oxide film 22 covers the entire surface of the particle body 21, the oxide film 22 may be provided only on a part of the surface.

Examples of a constituent material of the oxide film 22 include silicon oxide, aluminum oxide, titanium oxide, vanadium oxide, niobium oxide, chromium oxide, manganese oxide, tin oxide, and zinc oxide. Among these, one type, a mixture or a composite of two or more types, or the like can be used.

Among these, a silicon oxide is preferably used. The silicon oxide is an oxide represented by a composition formula SiOₓ (0<x≤2), and is preferably SiO₂.

An average thickness of the oxide film 22 is preferably 1 nm or more and 500 nm or less, more preferably 3 nm or more and 300 nm or less, and still more preferably 20 nm or more and 100 nm or less. When the average thickness of the oxide film 22 is within the above range, it is possible to prevent the oxide film 22 from becoming unnecessarily thick while securing functions of the oxide film 22 as described above. Accordingly, it is possible to prevent a decrease in magnetic characteristics of the magnetic metal particles 2 caused by an excessive increase in the ratio of the oxide film 22 while preventing aggregation and deterioration of the magnetic metal particles 2.

The average thickness of the oxide film 22 is a value obtained by observing cross sections of the particles of the magnetic metal particles 2 with an electron microscope and averaging the film thicknesses of the oxide films 22 at 10 or more locations.

A method of forming the oxide film 22 is not particularly limited, and examples thereof include wet film forming methods such as a sol-gel method including a Stober method, vapor phase film forming methods such as atomic layer deposition (ALD), chemical vapor deposition (CVD), and ion plating. Among these, a sol-gel method, in particular, a Stober method is useful since the oxide film 22 can be formed without unevenness at a low cost.

The Stober method is a method of forming the oxide film 22 by hydrolysis of a silicon alkoxide. As the silicon alkoxide, for example, TEOS (tetraethoxysilane, Si(OC₂H₅)₄) is preferably used.

### 1.2.1.3. Surface Modification Film

The surface modification film 23 covers the surface of the particle body 21 via the oxide film 22. Accordingly, dispersibility of the magnetic metal particles 2 in the dispersion medium 4 can be enhanced. Although it is preferable that the surface modification film 23 covers the entire surface of the oxide film 22 or the particle body 21, the surface modification film 23 may be provided only on a part of the surface.

A constituent material of the surface modification film 23 includes an organic compound derived from a coupling agent, a surfactant, or a polymer polymerized film. The coupling agent is a compound having a functional group and a hydrolyzable group. By using the coupling agent, the functional group can be introduced into the surface of the oxide film 22. Accordingly, aggregation of the particles of the magnetic metal particles 2 can be prevented, and the dispersibility in the dispersion medium 4 can be further enhanced. Accordingly, it is possible to implement the magnetic metal particles 2 which are excellent in followability to the change in the magnetic field and which can be uniformly dispersed in the dispersion medium 4 even at a high concentration.

The surface modification film 23 also contributes to enhancement in moisture resistance, rust resistance, and the like of the magnetic metal particles 2. By increasing the moisture resistance and the rust resistance, it is possible to prevent deterioration in the magnetic metal particles 2 due to moisture absorption and rust.

Examples of the functional group in the coupling agent include those containing an aliphatic hydrocarbon group, a cyclic structure-containing group, a fluoroalkyl group, a fluoroaryl group, a nitro group, an acyl group, and a cyano group. In particular, the aliphatic hydrocarbon group or the cyclic structure-containing group is preferably used.

Examples of the aliphatic hydrocarbon group include a branched or unbranched alkyl group. The number of carbon atoms in the alkyl group is not particularly limited, and is preferably 1 or more and 12 or less, and more preferably 1 or more and 6 or less. Accordingly, the magnetic metal particles 2 that are particularly favorably dispersed in the oil-based dispersion medium 4 are obtained.

The cyclic structure-containing group is a functional group having a cyclic structure. Examples of the cyclic structure-containing group include an aromatic hydrocarbon group, an alicyclic hydrocarbon group, and a cyclic ether group.

The aromatic hydrocarbon group is a residue obtained by removing hydrogen from an aromatic hydrocarbon, and the number of carbon atoms is preferably 6 or more and 20 or less. Examples of the aromatic hydrocarbon group include an aryl group, an alkylaryl group, an aminoaryl group, and a halogenated aryl group. Examples of the aryl group include a phenyl group, a tolyl group, a xylyl group, a naphthyl group, and an indenyl group. Examples of the alkylaryl group include a benzyl group, a methylbenzyl group, a phenethyl group, a methylphenethyl group, and a phenylbenzyl group.

The alicyclic hydrocarbon group is a residue obtained by removing hydrogen from an alicyclic hydrocarbon, and the number of carbon atoms is preferably 3 or more and 20 or less. Examples of the alicyclic hydrocarbon group include a cycloalkyl group and a cycloalkylalkyl group. Examples of the cycloalkyl group include a cyclopropyl group, a cyclobutyl group, a cyclopentyl group, and a cyclohexyl group. Examples of the cycloalkylalkyl group include a cyclopentylmethyl group and a cyclohexylmethyl group.

Examples of the cyclic ether group include an epoxy group, a 3,4-epoxycyclohexyl group, and an oxetanyl group.

The fluoroalkyl group is an alkyl group having 1 or more and 16 or less carbon atoms or a cycloalkyl group having 3 or more and 16 or less carbon atoms substituted with one or more fluorine atoms. In particular, the fluoroalkyl group is preferably a perfluoroalkyl group.

The fluoroaryl group is an aryl group having 6 or more and 20 or less carbon atoms substituted with one or more fluorine atoms. In particular, the fluoroaryl group is preferably a perfluoroaryl group.

Examples of the hydrolyzable group contained in the coupling agent include an alkoxy group, an acyloxy group, an aryloxy group, an aminoxy group, an amide group, a ketoxime group, an isocyanate group, and a halogen atom.

Examples of the coupling agent include a silane coupling agent, a titanium coupling agent, an aluminum coupling agent, and a zirconium coupling agent. In particular, the silane coupling agent is preferably used.

An addition amount of the coupling agent is preferably 0.01 parts by mass or more and 1.0 part by mass or less, and more preferably 0.02 parts by mass or more and 0.10 parts by mass or less, when the amount of the particle body 21 is 1 part by mass.

### 1.2.2. Additives

Examples of the additive 3 include a precipitation inhibitor, a detergent, a dispersant, an antioxidant, an antiwear agent, an extreme pressure agent, a friction modifier, and a surfactant. Among these, one type or a mixture of two or more types thereof is used.

Examples of the precipitation inhibitor include: fumed silica; fatty acid amide wax; organic molybdenum compounds such as molybdenum dialkyldithiocarbamates and molybdenum dialkyldithiophosphates; organic zinc compounds such as zinc dialkyldithiocarbamate and zinc dialkyldithiophosphate; and solid particles such as clay powders such as bentonite and hectorite. Among these, one type or a mixture of two or more types thereof is used. Such solid particles are particles having constituent materials different from that of the magnetic metal particles 2, and prevent the precipitation of the magnetic metal particles 2. Accordingly, even if a period in which no magnetic field is applied continues to be long, a decrease in the viscosity change width can be prevented.

A content of the precipitation inhibitor is preferably 5 mass % or less, and more preferably 0.5 mass % or more and 3 mass % or less, with respect to the total amount of the magnetorheological fluid 1. Accordingly, the precipitation of the magnetic metal particles 2 can be prevented without affecting the viscosity change width, and the viscosity change width can be stabilized over a long period of time.

Examples of the dispersant include an oleic acid salt, a naphthenic acid salt, a sulfonic acid salt, a phosphoric acid ester, stearic acid, a stearic acid salt, glycerol monooleate, sorbitan sesquioleate, lauric acid, a fatty acid, and an aliphatic alcohol.

A total content of the additive 3 is preferably 10 mass % or less, more preferably 8 mass % or less, and still more preferably 6 mass % or less, with respect to the total amount of the magnetorheological fluid 1. Accordingly, it is possible to prevent the function of the magnetic metal particles 2 from being inhibited by the additive 3.

The additive 3 may be added as necessary, and may be omitted.

### 1.2.3. Dispersion Medium

The dispersion medium 4 is not particularly limited as long as the dispersion medium 4 is a liquid capable of dispersing the magnetic metal particles 2 and the additives 3. Examples of the dispersion medium 4 include: oil such as silicone oil, poly-α-olefin base oil, aromatic synthetic oil, paraffin oil, alkylated phenyl ether oil, ether oil, ester oil, polybutene oil, polyalkylene glycols, mineral oil, vegetable oil, and animal oil; organic solvents such as toluene, xylene, and hexane; and ionic liquids (room temperature molten salts) such as an ethylmethylimidazolium salt, a 1-butyl-3-methylimidazolium salt, and a 1-methylpyrazolium salt. The dispersion medium 4 may be a mixture containing two or more types of these substances, or may be a mixture containing one or more types of these substances and a liquid other than the above.

Among these, examples of the ester oil include a diester produced from a monohydric alcohol and a dicarboxylic acid, a polyol ester produced from a polyol and a monocarboxylic acid, or a complex ester produced from a polyol, a monocarboxylic acid, and a polycarboxylic acid.

Examples of the diester include esters of dibasic acid such as adipic acid, azelaic acid, sebacic acid, and dodecanedioic acid. The dibasic acid is preferably an aliphatic dibasic acid having 4 to 36 carbon atoms. An alcohol residue constituting an ester moiety of the dibasic acid ester is preferably a monohydric alcohol residue having 4 to 26 carbon atoms. Examples of such a diester include dioctyl adipate, dioctyl sebacate, diisodecyl adipate, and dioctyl azelate.

As the polyol used in the polyol ester and the complex ester, specifically, hindered alcohols having no β-hydrogen, such as trimethylolpropane, pentaerythritol, and neopentyl glycol, are preferably used. Examples of the monocarboxylic acid used in the polyol ester and the complex ester include linear saturated fatty acids such as coconut oil fatty acid and stearic acid, linear unsaturated fatty acids such as oleic acid, and branched fatty acids such as isostearic acid.

As the polycarboxylic acid, linear saturated polycarboxylic acids such as succinic acid, glutaric acid, adipic acid, pimelic acid, suberic acid, azelaic acid, and sebacic acid are preferably used.

Examples of the alkylated phenyl ether oil include alkylated diphenyl ether and (alkylated) polyphenyl ether.

Examples of the polyalkylene glycols include polyethylene glycol, polypropylene glycol, polybutylene glycol, an ethylene oxide-propylene oxide copolymer, a propylene oxide-butylene oxide copolymer, and derivatives thereof.

### 1.3. Application Examples of Magnetorheological Fluid

Examples of an application of the magnetorheological fluid 1 include various apparatuses or devices using a stress difference when the application of the magnetic field is switched. Examples of such apparatuses or devices include a vibration damping device such as a damper and a shock absorber of a vehicle or a building, a braking device such as a brake, a power transmission device such as a clutch, a muscle portion or an end effector of a robot, a valve for controlling a liquid flow rate, a tactile presentation device, an acoustic device, a medical and welfare robot hand, a care hand, and a personal mobility.

### 1.4. Method for Producing Magnetorheological Fluid

In a method for producing the magnetorheological fluid 1, first, raw materials of the magnetorheological fluid 1 described above are mixed and stirred. Examples of a stirring method include stirring with a spatula, a vortex mixer, a high-shear mixer, and a low-frequency acoustic resonance mixer. A stirring time is appropriately set according to the stirring method, and is preferably 5 minutes or longer and 4 hours or shorter. A stirring temperature is appropriately set according to the stirring method, and is preferably 15° C. or higher and 70° C. or lower.

### 2. Vibration Damping Device

Next, a vibration damping device according to the embodiment will be described.

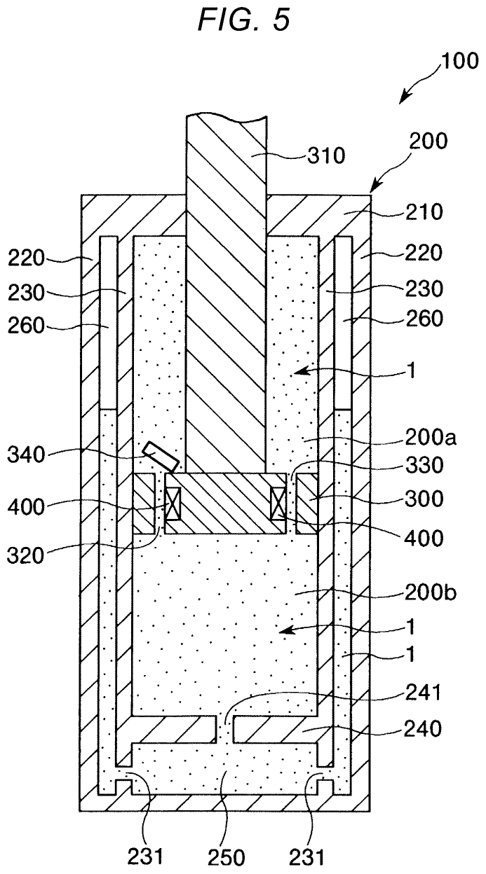

FIG. 5 is a longitudinal cross-sectional view showing a vibration damping device 100 according to the embodiment. In the vibration damping device 100 of FIG. 5, a posture during use is not particularly limited. In the following description, in FIG. 5, an upper side is referred to as “upper” and a lower side is referred to as “lower”.

The vibration damping device 100 shown in FIG. 5 includes a cylindrical cylinder 200 (a container) having closed upper and lower ends, a piston rod 310 passing through an upper portion 210 of the cylinder 200 from outside of the cylinder 200 and extending into the cylinder 200, and a piston 300 provided at a lower end of the piston rod 310 and sliding up and down in the cylinder 200. The magnetorheological fluid 1 is accommodated in the cylinder 200.

Such a vibration damping device 100 operates to expand and contract between a member coupled to an upper end portion of the piston rod 310 and a member coupled to a lower end portion of the cylinder 200. For example, in a case where the upper end portion of the piston rod 310 is coupled to a vehicle body of an automobile and the lower end portion of the cylinder 200 is coupled to a wheel or an axle, when a distance between the vehicle body and the wheel (the axle) expands and contracts, an expansion and contraction force is applied to the vibration damping device 100.

In the vibration damping device 100, the piston 300 slides in accordance with the expansion and contraction force applied between the members. During the sliding, the magnetorheological fluid 1 applies a resistance force to the piston 300 in a direction that alleviates the expansion and contraction force described above. As a result, the piston 300 functions as a shock absorber that alleviates and damps the expansion and contraction force applied between the members.

Further, the vibration damping device 100 includes coils 400 that are provided in the piston 300 and apply a magnetic field to the magnetorheological fluid 1 accommodated in the cylinder 200, and a power supply circuit (not shown) that applies a voltage to the coils 400. Accordingly, the coils 400 and the power supply circuit function as a magnetic field forming device.

The viscosity of the magnetorheological fluid 1 changes according to the presence or absence and a strength of the magnetic field. Therefore, the viscosity of the magnetorheological fluid 1 can be adjusted by appropriately setting the presence or absence and the strength of the magnetic field by the magnetic field forming device described above. By utilizing such characteristics, the vibration damping device 100 is a damping force variable damper capable of controlling a damping force.

Hereinafter, each part of the vibration damping device 100 will be described in detail.

The cylinder 200 shown in FIG. 5 has a two-layer structure (double cylinder type), and includes an outer cylinder 220 on an outer side and an inner cylinder 230 on an inner side.

A space inside the inner cylinder 230 is divided into a rod-side chamber 200a above the piston 300 and a piston-side chamber 200b below the piston 300.

Further, a first reservoir chamber 250 is provided below the piston-side chamber 200b via a base valve 240 provided to partition the space inside the inner cylinder 230.

The base valve 240 is provided with an orifice 241 penetrating through the base valve 240, and the piston-side chamber 200b and the first reservoir chamber 250 communicate with each other via the orifice 241.

A space between the outer cylinder 220 and the inner cylinder 230 is a second reservoir chamber 260. The first reservoir chamber 250 and the second reservoir chamber 260 are adjacent to each other via a lower end portion of the inner cylinder 230.

A portion separating the first reservoir chamber 250 of the inner cylinder 230 and the second reservoir chamber 260 is provided with an orifice 231 that penetrates the portion, and the first reservoir chamber 250 and the second reservoir chamber 260 communicate with each other via the orifice 231.

The cylinder 200 is made of a material excellent in mechanical characteristics and oil resistance, for example, made of various metal materials.

The piston rod 310 is formed of a rod-shaped member having high rigidity, passes through a central portion of the upper portion 210 of the cylinder 200, and extends inside and outside the cylinder 200.

The piston 300 is a cylindrical member, and an outer surface thereof is in sliding contact with an inner wall surface of the inner cylinder 230 of the cylinder 200. As described above, the space in the inner cylinder 230 is partitioned into the rod-side chamber 200a and the piston-side chamber 200b by the piston 300.

Two orifices 320 and 330 are provided to allow the piston 300 to penetrate. Each of the orifices 320 and 330 allows the rod-side chamber 200a and the piston-side chamber 200b to communicate with each other.

A valve body 340 is provided on an upper surface of the piston 300 in the vicinity of an upper end opening of the orifice 320. The valve body 340 is implemented to be able to take a state (an off state) in which the magnetorheological fluid 1 cannot flow through the orifice 320 by closing the upper end opening of the orifice 320, and a state (an on state) in which the upper end opening of the orifice 320 is open and the magnetorheological fluid 1 can flow through the orifice 320. The valve body 340 is a one-way valve having a function of passing a flow of the magnetorheological fluid 1 from the piston-side chamber 200b toward the rod-side chamber 200a and blocking the flow in an opposite direction. FIG. 5 shows the valve body 340 in the on state.

The valve body 340 allows and cut, as a driving force, a relative flow of the magnetorheological fluid 1 to the piston 300, which is generated according to the sliding of the piston 300 with respect to the cylinder 200. In order to shift the valve body 340 from the off state to the on state, it is necessary to apply a pressure of a predetermined magnitude or more to the valve body 340 by the magnetorheological fluid 1 flowing faster than a predetermined speed. Therefore, the valve body 340 is implemented to be in the on state only when the piston 300 slides at a speed equal to or higher than the predetermined speed. With such a valve body 340, in the vibration damping device 100, the damping force can be made different between when a sliding speed of the piston 300 is low and when the sliding speed of the piston 300 is high.

The ring-shaped coils 400 (a magnetic field generation unit) are provided in the piston 300. A part of an outer surface of each of the coils 400 faces each of the orifices 320 and 330.

As described above, the power supply circuit is coupled to the coils 400. When a voltage is applied to the coils 400, a magnetic field is generated around the coils 400.

In FIG. 5, the coils 400 are provided in the piston 300, and installation locations of the coils 400 are not particularly limited.

### 3. Effects of Embodiment

As described above, the magnetorheological fluid 1 according to the embodiment contains the dispersion medium 4 and the magnetic metal particles 2. The magnetic metal particles 2 are dispersed in the dispersion medium 4 and have a coercive force of 398 A/m or less (5 Oe or less). Further, in the magnetorheological fluid 1, a shear yield stress τ_{A} measured at a shear rate of 0.01/s after a magnetic field of 0.5 T is continuously applied for 480 seconds and the magnetic field is removed is less than 2.0 times a shear yield stress τ_{B} measured at a shear rate of 0.01/s before the magnetic field is applied.

Therefore, the magnetorheological fluid 1 has sufficient low-viscosity recoverability. Accordingly, even when the application and the removal of the magnetic field are repeated, the magnetorheological fluid 1 in which the viscosity change width is stable can be obtained. As a result, high performance and long-term reliability can be imparted to various devices using the magnetorheological fluid 1.

The magnetic field application period I in which the magnetic field of 0.5 T is applied for 80 seconds and the magnetic field removal period O in which the magnetic field is removed for 80 seconds may be repeated until a total of the magnetic field application periods I reaches 480 seconds. At this time, in the magnetorheological fluid 1, a maximum value τ_{A′_MAX} among shear yield stresses τ_{A}′ measured at a shear rate of 0.01/s during the magnetic field removal period O is preferably less than 2.0 times the shear yield stress τ_{B}.

Accordingly, the viscosity change width of the magnetorheological fluid 1 can be further stabilized, and the magnetorheological fluid 1 having good characteristics over a longer period of time can be obtained.

The average particle diameter of the magnetic metal particles 2 is preferably 0.05 μm or more and 20.0 μm or less. Accordingly, aggregation and precipitation of the magnetic metal particles 2 in a state in which no magnetic field is applied can be prevented. In addition, it is possible to prevent a decrease in the magnetic field responsiveness.

The magnetic metal particle 2 may contain the particle body 21 made of a Fe-based metal material. The Fe-based metal material has higher saturation magnetization and higher toughness and strength than ferrite and the like. Therefore, the Fe-based metal material is useful as the constituent material of the particle body 21 contained in the magnetic metal particle 2.

The oxide film 22 covering a surface of the particle body 21 may also be provided. The oxide film 22 can protect the particle body 21 and prevent aggregation, and can enhance moisture absorption resistance and rust resistance of the particle body 21.

The average thickness of the oxide film 22 is preferably 1 nm or more and 500 nm or less. Accordingly, it is possible to prevent the oxide film 22 from becoming unnecessarily thick while securing the function of the oxide film 22. As a result, it is possible to prevent a decrease in magnetic characteristics of the magnetic metal particles 2 caused by an excessive increase in the ratio of the oxide film 22 while preventing aggregation and deterioration of the magnetic metal particles 2.

In addition, the ratio D90/D50 is preferably 3.0 or less, where D50 is a particle diameter at which a cumulative value from a small diameter side is 50% and D90 is a particle diameter at which the cumulative value from the small diameter side is 90% in a cumulative distribution curve of the magnetic metal particles 2 obtained from a volume-based particle size distribution obtained by a laser diffraction and dispersion method.

Accordingly, aggregation of the magnetic metal particles 2 can be prevented, and destabilization of the viscosity change width can be prevented.

In addition, the magnetorheological fluid 1 according to the embodiment may contain the additives 3. The additives 3 contain solid particles having a constituent material different from that of the magnetic metal particles 2. Such solid particles prevent the precipitation of the magnetic metal particles 2. Accordingly, even if a period in which no magnetic field is applied continues to be long, a decrease in the viscosity change width can be prevented.

The vibration damping device 100 according to the embodiment includes the magnetorheological fluid 1, the cylinder 200 (a container), and the coils 400 (a magnetic field generation unit). The magnetorheological fluid 1 is stored in the cylinder 200. The coils 400 generate a magnetic field to act on the magnetorheological fluid 1 stored in the cylinder 200.

According to such a vibration damping device 100, since the viscosity of the magnetorheological fluid 1 can be adjusted by appropriately setting presence or absence and a strength of the magnetic field generated by the coils 400, a damping force variable damper capable of controlling a damping force can be obtained.

The magnetorheological fluid and the vibration damping device according to the present disclosure are described above based on the preferred embodiment, and the present disclosure is not limited thereto.

For example, the magnetorheological fluid and the vibration damping device according to the present disclosure may be obtained by adding any configuration to the above-described embodiment.

### EXAMPLES

Next, specific examples of the present disclosure will be described.

### 4. Preparation of Magnetorheological Fluid

### 4.1. Example 1

First, magnetic metal particles and solid particles were dispersed in a dispersion medium to prepare a magnetorheological fluid. As the magnetic metal particles, Fe₇₃Si₁₁Cr₂B₁₁C₃ alloy particles having an average particle diameter of 3.0 μm were used. This composition formula represents a ratio of constituent elements in terms of an atomic ratio. In addition, a Fe₇₃Si₁₁Cr₂B₁₁C₃ alloy is an amorphous alloy. A clay powder was used as the solid particles. A mixture of poly-α-olefin base oil and dioctyl sebacate was used as the dispersion medium.

A content of the magnetic metal particles was 85 mass % and a content of the solid particles was 2 mass % in the magnetorheological fluid.

### 4.2. Examples 2 and 3

A magnetorheological fluid was obtained in the same manner as in Example 1 except that the configuration of the magnetorheological fluid was changed as shown in Table 1.

### 4.3. Example 4

A magnetorheological fluid was prepared in the same manner as in Example 1 except that magnetic metal particles having Fe₇₃Si₁₁Cr₂B₁₁C₃ alloy particles having an average particle diameter of 3.0 μm as a particle body and a silicon oxide film as an oxide film were used, and the configuration of the magnetorheological fluid was changed as shown in Table 1. A Stober method was used to form the silicon oxide film. An average thickness of the silicon oxide film is as shown in Table 1.

### 4.4. Example 5

A magnetorheological fluid was obtained in the same manner as in Example 4 except that methyltrimethoxysilane was used as a silane coupling agent (CA) and the configuration of the magnetorheological fluid was changed as shown in Table 1. The silane coupling agent was supplied to cover the silicon oxide film prepared in Example 4, thereby forming a surface modification film. An addition amount of the silane coupling agent was 0.04 parts by mass with respect to 1 part by mass of the Fe₇₃Si₁₁Cr₂B₁₁C₃ alloy particles.

### 4.5. Examples 6 and 7

A magnetorheological fluid was obtained in the same manner as in Example 1 except that Fe₇₃Si₁₀B₁₅C₂ alloy particles were used as the magnetic metal particles, and the configuration of the magnetorheological fluid was changed as shown in Table 1. In addition, the Fe₇₃Si₁₀B₁₅C₂ alloy is an amorphous alloy.

### 4.6. Example 8

A magnetorheological fluid was obtained in the same manner as in Example 1 except that Fe_{73.5}Si_{13.5}Cu₁B₉Nb₃ alloy particles were used as the magnetic metal particles, and the configuration of the magnetorheological fluid was changed as shown in Table 1. In addition, the Fe_{73.5}Si_{13.5}Cu₁B₉Nb₃ alloy is a nanocrystal alloy.

### 4.7. Comparative Example 1

A magnetorheological fluid was obtained in the same manner as in Example 1 except that carbonyl iron particles having an average particle diameter of 5.0 μm were used instead of the Fe₇₃Si₁₁Cr₂B₁₁C₃ alloy particles.

### 4.8. Comparative Examples 2 and 3

A magnetorheological fluid was obtained in the same manner as in Comparative Example 1 except that the configuration of the magnetorheological fluid was changed as shown in Table 1.

### 5. Characteristic Acquisition of Magnetorheological Fluid

The magnetorheological fluid characteristics in each of Examples and Comparative Examples were obtained in the following manner.

### 5.1. Particle Size Distribution

The average particle diameter D50 and the ratio D90/D50 were measured or calculated for the magnetic metal particles used in the preparation of the magnetorheological fluid in each of Examples and Comparative Examples. Measurement results and calculation results are shown in Table 1.

### 5.2. Magnetic Characteristics

Saturation magnetization and a coercive force of the magnetic metal particles used in the preparation of the magnetorheological fluid in each of the Examples and Comparative Examples were measured. Measurement results are shown in Table 1.

### 5.3. τ₃, and Multiples of τ_{A}/τ_{B} and τ_{A′_MAX}/τ_{B}

For the magnetorheological fluid in each of Examples and Comparative Examples, the shear yield stress τ_{B} was measured, and the multiples of the shear yield stress τ_{A} and the shear yield stress τ_{A}′ _M with respect to the shear yield stress τ_{B} were calculated. Measurement results and calculation results are shown in Table 1.

### 6. Evaluation Results of Magnetorheological Fluid

The magnetorheological fluid in each of Examples and Comparative Examples was evaluated as follows.

### 6.1. Stability after 30 or 60 Times of Application

Application and removal of a magnetic field were repeated for the magnetorheological fluid in each of Examples and Comparative Examples. Then, multiples of a shear yield stress immediately after repeating 30 times and a shear yield stress immediately after repeating 60 times with respect to the shear yield stress τ_{B} immediately before applying the magnetic field were calculated, respectively. Then, the calculated multiples were evaluated in light of the following evaluation criteria.
A: the multiple is less than 2.0 times.
B: the multiple is 2.0 times or more and less than 4.0 times.
C: the multiple is 4.0 times or more and less than 6.0 times.
D: the multiple is 6.0 times or more and less than 12.0 times.
E: the multiple is 12.0 times or more.

Evaluation results are shown in Table 1.

### 6.2. Long-Term Stability

Application and removal of a magnetic field were repeated 100 times for the magnetorheological fluid in each of Examples and Comparative Examples. Then, a multiple of the shear yield stress immediately thereafter with respect to the shear yield stress τ_{B} immediately before applying the magnetic field was calculated. Then, the calculated multiple was evaluated in light of the following evaluation criteria.
A: the multiple is less than 2.0 times.
B: the multiple is 2.0 times or more and less than 4.0 times.
C: the multiple is 4.0 times or more and less than 6.0 times.
D: the multiple is 6.0 times or more and less than 12.0 times.
E: the multiple is 12.0 times or more.

Evaluation results are shown in Table 1.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Configuration | Composition | — | Fe-based amorphous metal | | | | | Fe-based | |
| of magneto- | of magnetic | | Fe₇₃Si₁₁Cr₂B₁₁C₃ | | | | | amorphous metal | |
| rheological | metal particles | | | | | | | Fe₇₃Si₁₀B₁₅C₂ | |
| fluid | Oxide film | — | — | — | — | Silicon oxide film | | — | — |
| | Surface | — | — | — | — | — | CA | — | — |
| | modification | | | | | | | | |
| | film | | | | | | | | |
| | Average | nm | — | — | — | 31 | 31 | — | — |
| | thickness of | | | | | | | | |
| | oxide film | | | | | | | | |
| | Average | μm | 3.0 | 7.5 | 5.6 | 3.0 | 3.0 | 5.0 | 12.0 |
| | particle | | | | | | | | |
| | diameter | | | | | | | | |
| | D50 | | | | | | | | |
| | Ratio D90/D50 | — | 2.2 | 2.8 | 1.7 | 2.2 | 2.2 | 1.8 | 1.4 |
| | Saturation | emu/g | 150 | 145 | 130 | 155 | 155 | 151 | 143 |
| | magnetization | | | | | | | | |
| | Coercive force | A/m | 390 | 230 | 140 | 350 | 350 | 50 | 28 |
| | | Oe | 4.9 | 2.9 | 1.8 | 4.4 | 4.4 | 0.6 | 0.4 |
| | T_{B} | Pa | 2.2 | 2.5 | 3.7 | 1.9 | 1.8 | 2.3 | 2.4 |
| | T_{A}/T_{B} | — | 1.9 | 1.5 | 1.3 | 1.6 | 1.5 | 1.1 | 1.2 |
| | T_{A′}_MAX/T_{B} | — | 1.9 | 1.6 | 1.4 | 1.7 | 1.6 | 1.2 | 1.3 |
| Evaluation | Stability after | — | A | A | A | A | A | A | A |
| result of | 30 times of | | | | | | | | |
| magneto- | application | | | | | | | | |
| rheological | Stability after | — | A | B | A | A | A | A | A |
| fluid | 60 times of | | | | | | | | |
| | application | | | | | | | | |
| | Long-term | — | B | B | A | B | A | A | B |
| | stability | | | | | | | | |

| | | | | Comparative | Comparative | Comparative |
|---|---|---|---|---|---|---|
| | | | Example 8 | Example 1 | Example 2 | Example 3 |
| Configuration | Composition | — | Fe-based | Carbonyl iron | | Fe-based |
| of magneto- | of magnetic | | nanocrystal metal | | | crystal metal |
| rheological | metal particles | | Fe_{73.5}Si_{13.5}Cu₁B₉Nb₃ | | | Fe₈₈Si₁₀Cr₃ |
| fluid | Oxide film | — | — | — | — | — |
| | Surface | — | — | — | — | — |
| | modification | | | | | |
| | film | | | | | |
| | Average | nm | — | — | — | — |
| | thickness of | | | | | |
| | oxide film | | | | | |
| | Average | μm | 3.0 | 5.0 | 5.0 | 4.0 |
| | particle | | | | | |
| | diameter | | | | | |
| | D50 | | | | | |
| | Ratio D90/D50 | — | 2.3 | 2.5 | 2.5 | 3.6 |
| | Saturation | emu/g | 150 | 210 | 201 | 184 |
| | magnetization | | | | | |
| | Coercive force | A/m | 43 | 810 | 495 | 470 |
| | | Oe | 0.5 | 10.2 | 6.2 | 5.9 |
| | T_{B} | Pa | 2.4 | 0.4 | 0.4 | 2.0 |
| | T_{A}/T_{B} | — | 1.1 | 21 | 9.4 | 2.7 |
| | T_{A′}_MAX/T_{B} | — | 1.2 | 24 | 10.6 | 3.5 |
| Evaluation | Stability after | — | A | E | D | C |
| result of | 30 times of | | | | | |
| magneto- | application | | | | | |
| rheological | Stability after | — | A | E | D | C |
| fluid | 60 times of | | | | | |
| | application | | | | | |
| | Long-term | — | A | E | E | D |
| | stability | | | | | |

As is apparent from Table 1, it is confirmed that the viscosity change width of the magnetorheological fluid in each Example is stable even when the application and the removal of the magnetic field were repeated for a long period of time. On the other hand, it is confirmed that, in the magnetorheological fluid in each Comparative Example, when the application and the removal of the magnetic field are repeated for a long period of time, the multiple of the shear yield stress with respect to the shear yield stress τ_{B} increases, and as a result, the viscosity change width decreases.

What is claimed is:

1. A magnetorheological fluid comprising:
a dispersion medium; and
magnetic metal particles dispersed in the dispersion medium and having a coercive force of 398 A/m or less, which is equivalent to 5 Oe or less, wherein
a shear yield stress τ_{A} measured at a shear rate of 0.01/s after a magnetic field of 0.5 T is continuously applied for 480 seconds and the magnetic field is removed is less than 2.0 times a shear yield stress τ_{B} measured at a shear rate of 0.01/s before the magnetic field is applied.

2. The magnetorheological fluid according to claim 1, wherein
when a magnetic field application period in which a magnetic field of 0.5 T is applied for 80 seconds and a magnetic field removal period in which the magnetic field is removed for 80 seconds are repeated until a total of the magnetic field application periods reaches 480 seconds, a maximum value τ_{A′_MAX} among shear yield stresses τ_{A}′ measured at a shear rate of 0.01/s during the magnetic field removal periods is less than 2.0 times the shear yield stress τ_{B}.

3. The magnetorheological fluid according to claim 1, wherein
an average particle diameter of the magnetic metal particles is 0.05 μm or more and 20.0 μm or less.

4. The magnetorheological fluid according to claim 1, wherein
the magnetic metal particles have particle bodies formed of a Fe-based metal material.

5. The magnetorheological fluid according to claim 4, further comprising:
an oxide film configured to cover a surface of the particle body.

6. The magnetorheological fluid according to claim 5, wherein
an average thickness of the oxide film is 1 nm or more and 500 nm or less.

7. The magnetorheological fluid according to claim 1, wherein
a ratio D90/D50 is 3.0 or less, where D50 is a particle diameter at which a cumulative value from a small diameter side is 50% and D90 is a particle diameter at which the cumulative value from the small diameter side is 90% in a cumulative distribution curve of the magnetic metal particles obtained from a volume-based particle size distribution obtained by a laser diffraction and dispersion method.

8. The magnetorheological fluid according to claim 1, further comprising:
an additive, wherein
the additive is solid particles having a constituent material different from that of the magnetic metal particles.

9. A vibration damping device comprising:
the magnetorheological fluid according to claim 1;
a container configured to store the magnetorheological fluid; and
a magnetic field generation unit configured to generate a magnetic field to act on the magnetorheological fluid stored in the container.
